(19) United States
(12) Patent Application Publication
(10) Pub. No.: US 2012/0287241 A1
(43) Pub. Date: Nov. 15, 2012

(54) SYSTEM, METHOD, AND COMPUTER PROGRAM PRODUCT FOR AQUATIC DISPLAY

(75) Inventors: Colin William Foord, Miami, FL (US); Jared Dennison McKay, Miami, FL (US)

(73) Assignee: Coral Morphologic, LLC, Miami, FL (US)

(21) Appl. No.: 13/106,234

(22) Filed: May 12, 2011

(51) Int. Cl. H04N 13/02; H04N 7/18

(52) U.S. Cl. 348/46; 348/143; 348/E13.074; 348/E07.085

(57) ABSTRACT

The present disclosure relates to a computer-implemented method for providing an aquatic display. The method may include capturing real-time live video of aquatic content. The method may further include providing the real-time live video of aquatic content to one or more display devices and displaying the real-time live video of aquatic content as a screensaver. Numerous other features are also within the scope of the present disclosure.

### FIELD OF THE INVENTION

The present disclosure relates to content production, and more specifically, to a system, method and computer program product for providing an aquatic display.

### DISCUSSION OF THE RELATED ART

An aquarium is an at least partially transparent habitat in which water-dwelling plants, fish, and/or other marine wildlife are kept. A virtual aquarium is a computer program which uses graphics to reproduce an aquarium on a personal computer. Virtual aquariums are available for purchase on DVDs or other storage media. These stored virtual aquariums allow the user to watch footage of previously recorded aquariums.

### SUMMARY OF INVENTION

In one or more embodiments of the present disclosure, a computer-implemented method for providing an aquatic display is provided. The method may include capturing real-time live video of aquatic content and providing the real-time live video of aquatic content to one or more display devices. The method may further include displaying the real-time live video of aquatic content as a screensaver.

One or more of the following features may be included. In some embodiments, the method may include providing a user with an option of selecting from a plurality of different types of aquatic content. The method may further include determining a ranking of one or more aquatic content types based upon, at least in part, subscriber feedback. In some embodiments, providing may include providing three-dimensional real-time live video of the aquatic content. The method may also include providing a user with the option of selecting one or more types of subscription based memberships. In some embodiments, the one or more types of memberships include private, commercial, educational, and therapeutic memberships. In some embodiments, the one or more display devices includes at least one a personal computer, a laptop computer, a mobile computing device, a notebook computer, and a television. The method may also include linking a particular type of aquatic content with a user-selectable descriptor.

In another embodiment of the present disclosure a system for providing an aquatic display is provided. The system may include a computing device having at least one processor configured to capture real-time live video of aquatic content, the device further configured to provide the real-time live video of aquatic content to one or more display devices, the one or more display devices configured to display the real-time live video of aquatic content as a screensaver.

One or more of the following features may be included. In some embodiments, the at least one processor may be further configured to provide a user with an option of selecting from a plurality of different types of aquatic content. The system may be further configured to determine a ranking of one or more aquatic content types based upon, at least in part, subscriber feedback. The one or more display devices may be configured to provide three-dimensional real-time live video of the aquatic content. The one or more display devices may be configured to provide a user with the option of selecting one or more types of subscription based memberships. The one or more types of memberships may include at least one of private, commercial, educational, and therapeutic memberships. The one or more display devices may include at least one a personal computer, a laptop computer, a mobile computing device, a notebook computer, and a television. The system may be further configured to link a particular type of aquatic content with a user-selectable descriptor.

In yet another embodiment of the present disclosure a computer-readable storage medium having stored thereon instructions that when executed by a machine result in a number of operations is provided. Some operations may include capturing real-time live video of aquatic content and providing the real-time live video of aquatic content to one or more display devices. Operations may further include displaying the real-time live video of aquatic content as a screensaver.

One or more of the following features may be included. In some embodiments, Operations may include providing a user with an option of selecting from a plurality of different types of aquatic content and determining a ranking of one or more aquatic content types based upon, at least in part, subscriber feedback. In some embodiments, providing may includes providing three-dimensional real-time live video of the aquatic content. Operations may further include providing a user with the option of selecting one or more types of subscription based memberships. The one or more types of memberships may include private, commercial, educational, and therapeutic memberships. The one or more display devices may include at least one a personal computer, a laptop computer, a mobile computing device, a notebook computer, and a television. Operations may further include linking a particular type of aquatic content with a user-selectable descriptor.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 is a diagram depicting an embodiment of a system in accordance with the present disclosure;

FIG. 2 is a diagram depicting a computing device consistent with an embodiment of the present disclosure;

FIG. 3 is a diagram depicting a computing device consistent with an embodiment of the present disclosure;

FIG. 4 is a diagram depicting a computing device consistent with an embodiment of the present disclosure; and

FIG. 5 is a flowchart depicting operations incorporating the aquatic display process in accordance with an embodiment of the present disclosure.

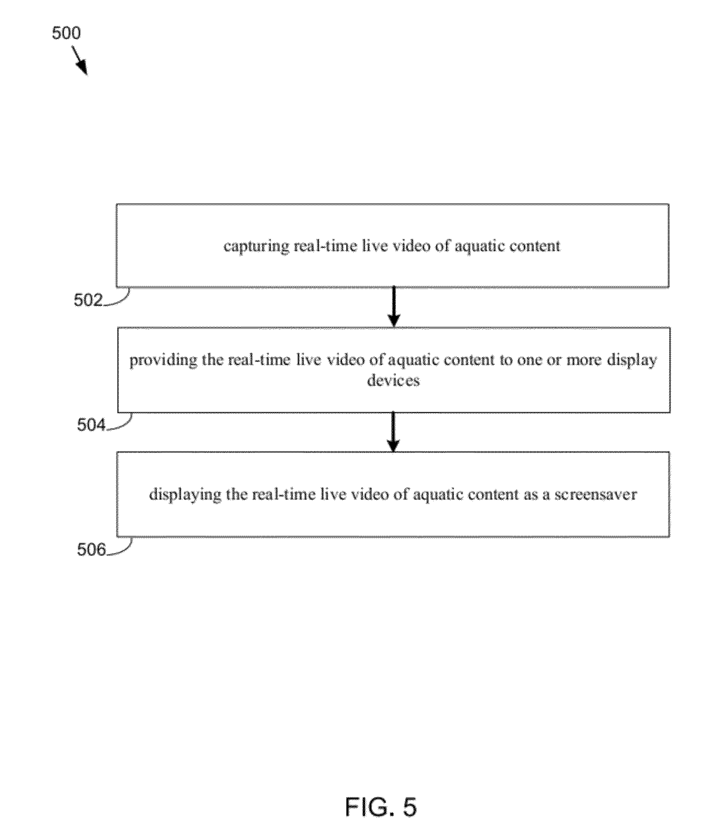

### DETAILED DESCRIPTION

Reference will now be made in detail to the embodiments of the present disclosure, examples of which are illustrated in the accompanying drawings. The present disclosure may, however, be embodied in many different forms and should not be construed as being limited to the embodiments set forth herein. Rather, these embodiments are provided so that this disclosure will be thorough and complete, and will fully convey the concept of the disclosure to those skilled in the art.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

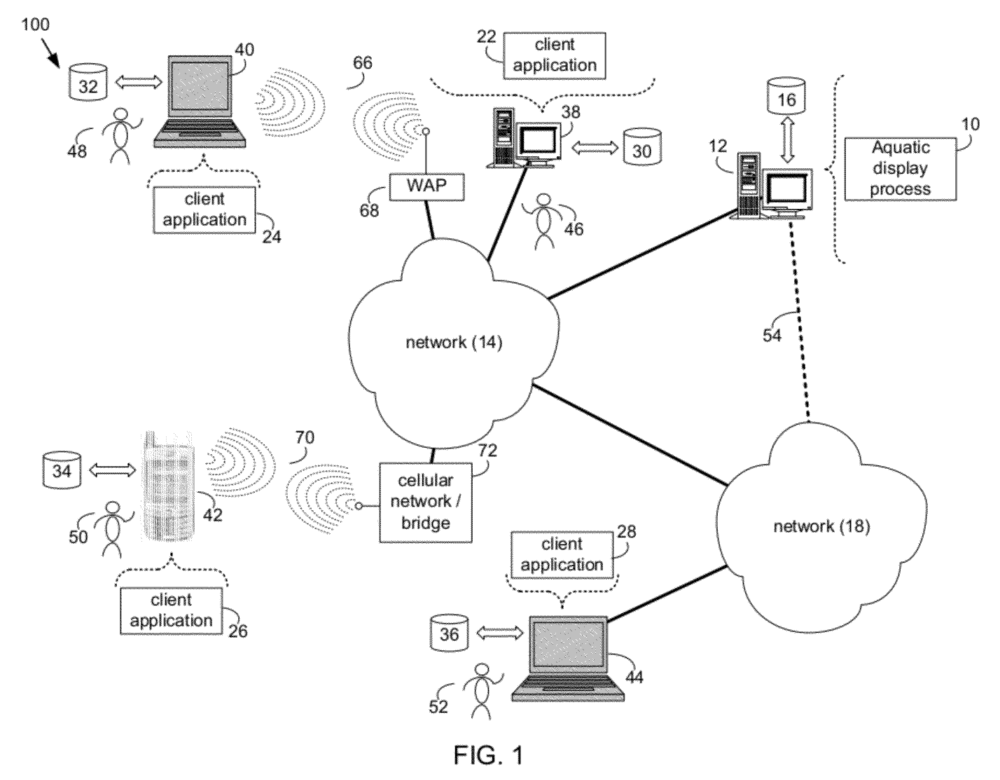

Referring to FIG. 1, there is shown aquatic display process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® Server; Novell® NetWare®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.) Additionally/alternatively, the aquatic display process may reside on and be executed, in whole or in part, by a client electronic device, such as a personal computer, notebook computer, personal digital assistant, or the like.

As will be discussed below in greater detail, aquatic display process 10 may capture real-time live video of aquatic content. Aquatic display process 10 may provide the real-time live video of aquatic content to one or more display devices. Aquatic display process 10 may display the real-time live video of aquatic content as a screens aver.

The instruction sets and subroutines of aquatic display process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM). Storage device 16 may include various types of files and file types.

Server computer 12 may execute a web server application, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Aquatic display process 10 may be a stand alone application, or may be an applet/application/script that may interact with and/or be executed within EDA application 20. In addition/as an alternative to being a server-side process, the aquatic display process may be a client-side process (not shown) that may reside on a client electronic device (described below). Further, the aquatic display process may be a hybrid server-side/client-side process. As such, the aquatic display process may reside, in whole, or in part, on server computer 12 and/or one or more client electronic devices.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44 (respectively). Storage devices 30, 32, 34, 36 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, mobile computing device 42 (such as a smart phone, netbook, or the like), notebook computer 44, for example. Using client applications 22, 24, 26, 28, users 46, 48, 50, 52 may utilize aquatic display process 10.

Users 46, 48, 50, 52 may access aquatic display process 10 directly through the device on which the client application (e.g., client applications 22, 24, 26, 28) is executed, namely client electronic devices 38, 40, 42, 44, for example. Users 46, 48, 50, 52 may access aquatic display process 10 directly through network 14 or through secondary network 18. Further, server computer 12 (i.e., the computer that executes aquatic display process 10) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 66 established between laptop computer 40 and wireless access point (i.e., WAP) 68, which is shown directly coupled to network 14. WAP 68 may be, for example, an IEEE 802.11a, 802.11b, 802.11g, Wi-Fi, and/or Bluetooth device that is capable of establishing wireless communication channel 66 between laptop computer 40 and WAP 68. Mobile computing device 42 is shown wirelessly coupled to network 14 via wireless communication channel 70 established between mobile computing device 42 and cellular network/bridge 72, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows, Microsoft Windows CEO, Red Hat Linux, or other suitable operating system. (Windows CE is a registered trademark of Microsoft Corporation in the United States, other countries, or both.)

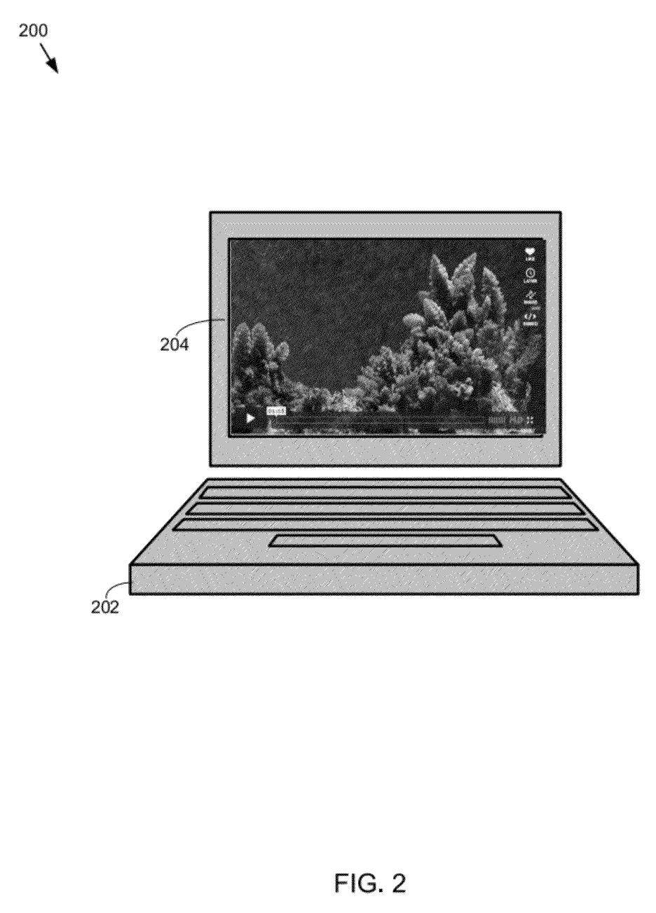

Referring now to FIG. 2, an exemplary display device 200 configured to display aquatic content is provided. In this particular embodiment, a laptop computer is shown, however, it should be noted that numerous other types of display devices may be used without departing from the scope of the present disclosure. Some display devices may include, but are not limited to, personal computers, a laptop computers, mobile computing devices, a notebook computer, and a television.

As discussed above, in some embodiments, aquatic display process 10 may include capturing real-time live video of aquatic content, providing the real-time live video of aquatic content to one or more display devices (e.g., display device 202) and displaying the real-time live video of aquatic content as a screensaver.

In some embodiments, aquatic display process 10 may include a subscription-based service, which may provide subscribers with on-demand, high-definition video of live aquarium content to their computers, smart phones, televisions, and/or dedicated Internet-connected screens. Content for this service may originate in one or more studios where specific aquariums are set up to be recorded. Filming of these aquariums may be done in such a way that some or all of the technical components of the aquarium may be removed or disguised from view, resulting in an edge-to-edge, pristine view into an aquatic world, unfettered by hoses, wires, filters, tank edges, and other hardware. Film of these aquariums may be directly uploaded to the Internet such that it can then be streamed directly to subscribers who can access it from any Internet-accessible device or Broadband service (e.g., AppleTV, Google TV, Netflix, etc.). Digital monitoring of the aquarium chemistry (e.g. temperature, pH, salinity, etc) may also be accessible.

In some embodiments, and as shown in FIG. 2, aquatic display process 10 may be configured to generate and/or display a living aquarium screensaver 204. In this way, and in addition to immediate, on-demand access, these digital aquascapes may also be offered as a ‘living screensaver’ option, such that aquarium footage may be, for example, automatically switched on when a subscriber's computer or television screen is idle for a set period of time. In some embodiments, aquatic display process 10 may be configured to implement streaming film of a live aquarium as a screensaver 204. In some embodiments, aquatic display process 10 may be configured to transmit and/or display three-dimensional and/or high definition real-time live video.

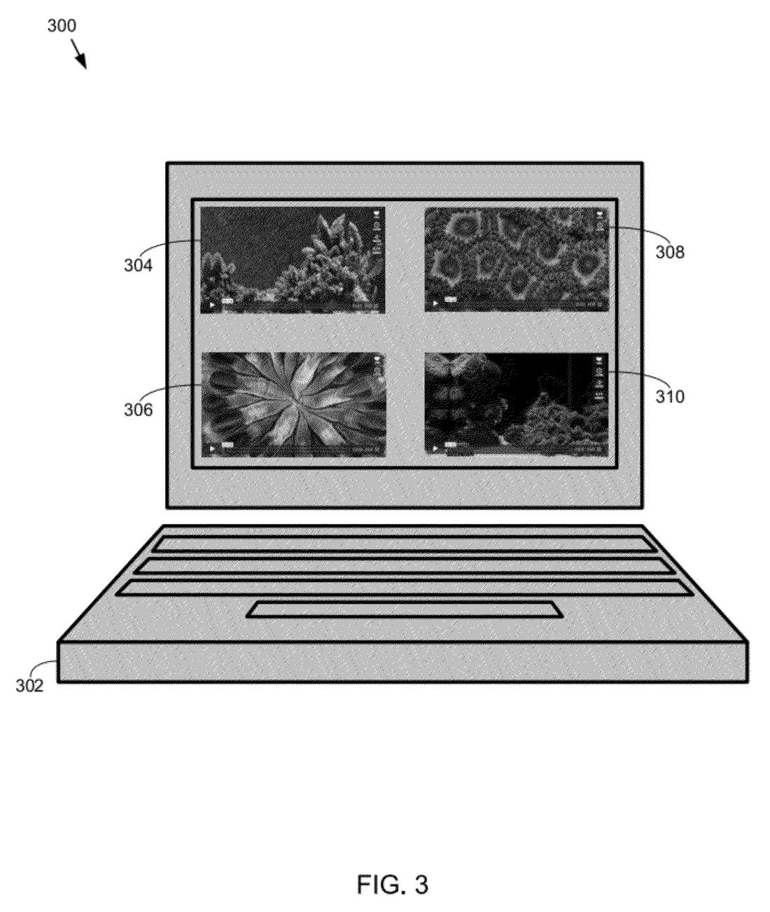

Referring now to FIG. 3, aquatic display process 10 may be configured to provide a user with an option of selecting from a plurality of different types of aquatic content. FIG. 3 depicts display device 302 depicting four distinct user-selectable types 304, 306, 308, and 310 of aquatic content. In this way, aquatic display process 10 may display multiple aquatic content types. For example, each of aquatic content types 304, 306, 308, and 310 may correspond to a different aquarium being filmed, or alternatively as different parts of the same aquarium. Aquatic display process 10 may allow for a user to view one or more of these types.

In this way, aquatic display process 10 may act as an aquarium portal. Rather than providing a single channel of only one aquarium, subscribers may have access to multiple different aquariums to choose from at any given time. This ‘aquarium portal’ may provide the subscriber with multiple options to choose from depending on mood, aesthetic, design, or interest. For example, in some embodiments, freshwater planted aquariums may offer a serene, tranquil ambiance, while saltwater coral reef aquariums may provide a much more stimulating, hyper-colorful viewing experience. Depending on the design, aquariums may be set up and filmed for several hours at a time each day, for weeks, months, or years. Thus subscribers may be able to see these aquariums grow and evolve in real-time, while creating a bond with the aquarium inhabitant in the same way that home aquarist does with their pet fish in a physical aquarium installation. Aquatic display process 10 may use subscriber feedback to determine which aquariums are most popular, and thus maintained the longest. ‘Retired’ aquariums may remain accessible to subscribers such that over time a back-catalog (a library) of aquariums may be accessible and viewable long after the actual aquarium is dismantled.

In some embodiments, aquatic display process 10 may include determining a ranking of one or more aquatic content types based upon, at least in part, subscriber feedback. This ranking may be determined in any number of ways. For example, users may be asked which aquariums they prefer. Additionally and/or alternatively, aquatic display process 10 may automatically determine which aquatic display types are preferred based upon the selections of various users. For example, when provided with the option of aquatic display types 304, 306, 308, and 310, the ranking may be determined based upon which display types are most frequently selected. Numerous alternative arrangements are also within the scope of the present disclosure.

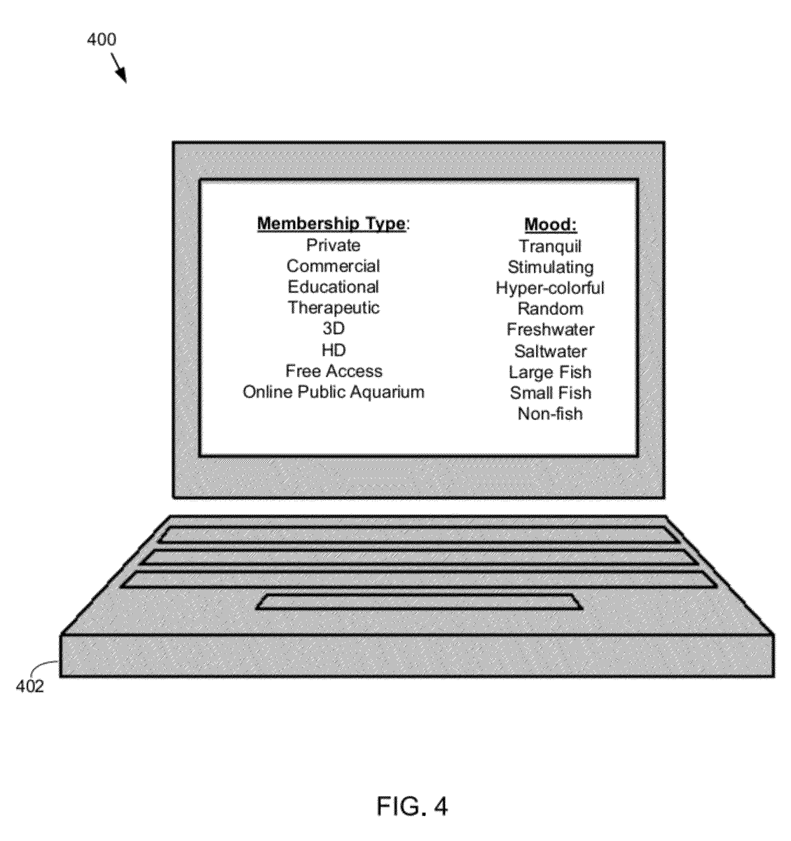

Referring now to FIG. 4, aquatic display process 10 may be configured to provide a user with the option of selecting one or more types of subscription based memberships on one or more display devices 402. The one or more types of memberships may include but are not limited to, private, commercial, educational, and therapeutic memberships.

In some embodiments, in a private membership, subscribers may pay a monthly fee of varying membership levels depending on the amount of access they desire. Basic, private subscribers (e.g., personal/home use) may be able to select several different aquariums of their choosing every month. Premium, private subscribers (e.g., personal/home use) may have access to all current and past aquarium film content. In some embodiments, the premium subscribers may be provided with three-dimensional, digital, and/or high definition options for those equipped.

In some embodiments, commercial subscriptions/licenses may be available to businesses that wish to have independent control on multiple screens/televisions. For example, hotels and cruise ships may wish to provide this service to their patrons' in-room programming. Airports, restaurants, and commercial lobbies/waiting rooms are other examples of commercial subscribers to the service.

In some embodiments, educational subscription/licenses may be made available to school systems, museums, etc. Supplemental curriculum and educational material may be provided in conjunction with this type of subscription.

In some embodiments, specific aquariums may be designed and offered to health and therapeutic industries as a subscription service. This may allow the scientifically-proven therapeutic effects of an aquarium to be made easily available to hospitals, nursing homes, rehabilitation centers, and mental health service providers. These aquariums may be designed to reduce stress and provide mental engagement and may be useful in situations where a physical aquarium installation is not practical or cost effective. ‘Large format/macro’ aquarium content may be filmed specifically for the vision-impaired, who otherwise have difficulty enjoying a typical aquarium. At least one aquarium may be free to access for the public including, for example, at least 4 hours of unrepeated film.

In some embodiments, the aquatic display process 10 may include an online public aquarium. The end result of multiple aquariums being carefully documented may result in an enormous cache of aquatic life being cataloged on the Internet. These creatures may be cataloged with corresponding natural history information in much the same way that a public aquarium provides information to support their exhibits. This may allow children and adults alike to learn about these aquatic lifeforms in high-definition clarity from anywhere on the planet.

In some embodiments, aquatic display process 10 may link a particular type of aquatic content with a user-selectable descriptor. For example, in FIG. 4 a user may select from one or more of the descriptors shown. A user who wishes to view freshwater high definition content may select the “freshwater” and “HD” icons from the display provided by display device 402. A “random” selection may toggle between multiple aquariums, thus allowing the viewer to see different aquatic content types. It is envisioned that the speed at which this toggling occurs may also be set by the user. Although the “membership type” and “mood” screens are shown together simultaneously it is envisioned that these options may be provided as distinct screens as well. For example, a selection of the “educational” membership type may offer a subset of options that may be less than the entirety of options(e.g. small fish and freshwater).

As used in any embodiment described herein, “circuitry” may include, for example, singly or in any combination, hardwired circuitry, programmable circuitry, state machine circuitry, and/or firmware that stores instructions executed by programmable circuitry. It should be understood at the outset that any of the operations and/or operative components described in any embodiment herein may be implemented in software, firmware, hardwired circuitry and/or any combination thereof.

It will be apparent to those skilled in the art that various modifications and variations can be made in the embodiments of the present disclosure without departing from the spirit or scope of the present disclosure. Thus, it is intended that embodiments of the present disclosure cover the modifications and variations provided they come within the scope of the appended claims and their equivalents.

What is claimed is:

1. A method for providing an aquatic display comprising:
capturing real-time live video of aquatic content;
providing the real-time live video of aquatic content to one or more display devices; and
displaying the real-time live video of aquatic content as a screensaver.

2. The method of claim 1, further comprising:
providing a user with an option of selecting from a plurality of different types of aquatic content.

3. The method of claim 1, further comprising:
determining a ranking of one or more aquatic content types based upon, at least in part, subscriber feedback.

4. The method of claim 1, wherein providing includes providing three-dimensional real-time live video of the aquatic content.

5. The method of claim 1, further comprising:
providing a user with the option of selecting one or more types of subscription based memberships.

6. The method of claim 5, wherein the one or more types of memberships include private, commercial, educational, and therapeutic memberships.

7. The method of claim 1, wherein the one or more display devices includes at least one a personal computer, a laptop computer, a mobile computing device, a notebook computer, and a television.

8. The method of claim 1, further comprising:
linking a particular type of aquatic content with a user-selectable descriptor.

9. A system for providing an aquatic display comprising:
a device configured to capture real-time live video of aquatic content, the device further configured to provide the real-time live video of aquatic content to one or more display devices, the one or more display devices configured to display the real-time live video of aquatic content as a screensaver.

10. The system of claim 9, wherein the system is further configured to provide a user with an option of selecting from a plurality of different types of aquatic content.

11. The system of claim 9, wherein the system is further configured to determine a ranking of one or more aquatic content types based upon, at least in part, subscriber feedback.

12. The system of claim 9, wherein the one or more display devices is configured to provide three-dimensional real-time live video of the aquatic content.

13. The system of claim 9, wherein the one or more display devices is configured to provide a user with the option of selecting one or more types of subscription based memberships.

14. The system of claim 13, wherein the one or more types of memberships include at least one of private, commercial, educational, and therapeutic memberships.

15. The system of claim 9, wherein the one or more display devices includes at least one a personal computer, a laptop computer, a mobile computing device, a notebook computer, and a television.

16. The system of claim 9, wherein the system is further configured to link a particular type of aquatic content with a user-selectable descriptor.

17. A computer-readable storage medium for providing an aquatic display, the computer-readable storage medium having stored thereon instructions that when executed by a machine result in the following operations:
capturing real-time live video of aquatic content;
providing the real-time live video of aquatic content to one or more display devices; and
displaying the real-time live video of aquatic content as a screensaver.

18. The computer readable storage medium of claim 17, wherein operations further comprise:
providing a user with an option of selecting from a plurality of different types of aquatic content.

19. The computer readable storage medium of claim 17, wherein operations further comprise:
determining a ranking of one or more aquatic content types based upon, at least in part, subscriber feedback.

20. The computer readable storage medium of claim 17, wherein providing includes providing three-dimensional real-time live video of the aquatic content.

21. The computer readable storage medium of claim 17, wherein operations further comprise:
providing a user with the option of selecting one or more types of subscription based memberships.

22. The computer readable storage medium of claim 21, wherein the one or more types of memberships include private, commercial, educational, and therapeutic memberships.

23. The computer readable storage medium of claim 17, wherein the one or more display devices includes at least one a personal computer, a laptop computer, a mobile computing device, a notebook computer, and a television.

24. The computer readable storage medium of claim 17, wherein operations further comprise:
linking a particular type of aquatic content with a user-selectable descriptor.
